(19) United States
(12) Patent Application Publication
(10) Pub. No.: US 2025/0141295 A1
(43) Pub. Date: May 1, 2025

(54) In-Wheel Motor

(71) Applicant: Ticona LLC, Florence, KY (US)

(72) Inventors: Shuai Xu, Shanghai (CN); Fangfang Tao, Shanghai (CN)

(21) Appl. No.: 18/687,511

(22) PCT Filed: Jul. 22, 2022
(86) PCT No.: PCT/CN2022/107319

§ 371 Date: Feb. 28, 2024

(51) Int. Cl. H02K 5/02; B60K 7/00; C08K 3/04; C08K 3/38; H02K 5/08; H02K 11/33; H02K 21/16

(52) U.S. Cl. CPC H02K 5/02; B60K 7/0007; C08K 3/04; C08K 3/38; H02K 5/08; H02K 11/33; H02K 21/16; C08K 2003/385; C08K 2201/001; H02K 2211/03

(57) ABSTRACT

An in-wheel motor that comprises a housing that is supported in an inner space of a wheel portion and a stator core that is supported inside the housing is provided. The motor includes a polymer composition that comprises a polymer matrix that includes a thermotropic liquid crystalline polymer and a thermally conductive filler distributed within the polymer matrix. The polymer composition exhibits an in-plane thermal conductivity of about 2 W/m-K or more as determined in accordance with ASTM E1461-13 (2022).

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. In some cases, the electric vehicle may contain a motor structure integrally mounted with a wheel to rotate the wheel and help drive the vehicle. Unfortunately, heat can build up in the wheel motor, primarily from the application of brakes but also from the operation of the motor itself. It is widely recognized that motor output decreases as the motor temperature increases. Brake heat can be specifically problematic because heat from this source builds up very rapidly and can subject wheels or other structures to thermal spikes that can unacceptably weaken these structures. Arrangements for cooling wheel motors have been proposed in the past, such as providing a coolant to help decrease temperature. While effective, the coolant and associated piping can additional unacceptable weight and size to the vehicle. As such, a need currently exists for an in-wheel motor and an electric wheel capable of efficiently dissipating heat.

### SUMMARY OF THE INVENTION

In accordance with one embodiment of the present invention, an in-wheel motor is disclosed that comprises a housing that is supported in an inner space of a wheel portion and a stator core that is supported inside the housing. The motor includes a polymer composition that comprises a polymer matrix that includes a thermotropic liquid crystalline polymer and a thermally conductive filler distributed within the polymer matrix. The polymer composition exhibits an in-plane thermal conductivity of about 2 W/m-K or more as determined in accordance with ASTM E1461-13 (2022).

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is an exploded perspective view of one embodiment of an in-wheel motor that may be formed in accordance with the present invention;

FIG. 2 is an exploded perspective view of the drive device of the in-wheel motor of FIG. 1;

FIG. 3 is an exploded perspective view of the drive board of the drive device of FIG. 2; and

FIG. 4 illustrates one embodiment of an electric vehicle that may employ an in-wheel motor formed in accordance with the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to an in-wheel motor, such as employed in electric vehicles. The in-wheel motor includes a housing that is supported in an inner space of a wheel portion and a stator core that is supported inside the housing. Notably, the motor contains a polymer composition that includes a liquid crystalline polymer and exhibits high thermal conductivity. Such high thermal conductivity allows the composition to be capable of creating a thermal pathway for heat transfer away from conductive elements of the motor. In this manner, “hot spots” can be quickly eliminated and the overall temperature can be lowered during use. The polymer composition may, for example, exhibit an in-plane (or “flow”) thermal conductivity of about 2 W/m-K or more, in some embodiments from about 2.5 to about 15 W/m-K, in some embodiments about 3 to about 10 W/m-K, and in some embodiments, from about 4 to about 8 W/m-K, as determined in accordance with ASTM E 1461-13 (2022). Similarly, the polymer composition may exhibit a cross-plane (or “cross-flow”) thermal conductivity of about 0.8 W/m-K or more, in some embodiments from about 1 to about 12 W/m-K, and in some embodiments, from about 2 to about 8 W/m-K, as determined in accordance with ASTM E 1461-13 (2022). The composition may also exhibit a through-plane thermal conductivity of about 0.2 W/m-K or more, in some embodiments about 0.3 W/m-K or more, in some embodiments about 0.5 to about 4 W/m-K, and in some embodiments, from about 0.6 to about 2 W/m-K, as determined in accordance with ASTM E 1461-13 (2022).

While being thermally conductive, the polymer composition may nevertheless may be electrically insulative and maintain a high degree of short-term dielectric strength even when exposed to an electric field. The “dielectric strength” generally refers to the voltage that the material can withstand before breakdown occurs. For instance, the polymer composition may generally exhibit a dielectric strength of about 10 kilovolts per millimeter (kV/mm) or more, in some embodiments about 15 kV/mm or more, and in some embodiments, from about 25 kV/mm to about 60 kV/mm, such as determined in accordance with IEC 60234-1:2013. The insulative properties of the polymer composition may also be characterized by a high comparative tracking index (“CTI”), such as about 150 volts or more, in some embodiments about 170 volts or more, in some embodiments about 200 volts or more, and in some embodiments, from about 220 to about 350 volts, such as determined in accordance with IEC 60112:2003 at a thickness of 3 millimeters.

The deflection temperature under load (“DTUL”), a measure of short term heat resistance may also remain relatively high. For instance, the DTUL may be about 170° C. or more, in some embodiments about 200° C. or more, in some embodiments from about 210° C. to about 300° C., and in some embodiments, from about 220° C. to about 280° C., such as determined in accordance with ISO 75:2013 at a load of 1.8 MPa. Even at such DTUL values, the ratio of the melting temperature to the DTUL value may still remain relatively high. For example, the ratio may range from about 0.5 to about 1.00, in some embodiments from about 0.6 to about 0.95, and in some embodiments, from about 0.65 to about 0.85. The specific melting temperature of the polymer composition may, for instance, be from about 250° C. to about 440° C., in some embodiments from about 260° C. to about 400° C., and in some embodiments, from about 300° C. to about 380° C. The polymer composition may also exhibit a high degree of flowability. More particularly, the composition may exhibit a melt viscosity of about 300 Pa-s or less, in some embodiments about 150 Pa-s or less, in some embodiments from about 5 to about 100 Pa-s, in some embodiments from about 10 to about 95 Pa-s, and in some embodiments, from about 15 to about 80 Pa-s, as determined in accordance with ISO 11443:2021 at a shear rate of 1,000 s⁻¹ and temperature of about 15° C. above the melting temperature of the composition (e.g., about 350° C.).

Despite having the properties noted above, the polymer composition may nevertheless maintain a high degree of strength, which can provide enhanced flexibility and impact resistance. The polymer composition may, for example, exhibit a tensile stress at break (i.e., strength) of from about 40 MPa to about 300 MPa, in some embodiments from about 50 MPa to about 250 MPa, and in some embodiments, from about 70 to about 200 MPa; a tensile break strain (i.e., elongation) of about 0.5% or more, in some embodiments from about 1% to about 8%, and in some embodiments, from about 2% to about 5%; and/or a tensile modulus of from about 5,000 to about 30,000 MPa, in some embodiments from about 6,000 MPa to about 25,000 MPa, and in some embodiments, from about 9,000 MPa to about 22,000 MPa. The tensile properties may be determined in accordance with ISO 527:2019 at a temperature of 23° C. The composition may also exhibit a flexural strength of about 20 MPa or more, in some embodiments from about 50 to about 300 MPa, in some embodiments from about 70 to about 250 MPa, and in some embodiments, from about 80 to about 200 MPa and/or a flexural modulus of about 10,000 MPa or less, in some embodiments from about 5,000 MPa to about 30,000 MPa, in some embodiments from about 8,000 MPa to about 25,000 MPa, and in some embodiments, from about 9,000 MPa to about 20,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit an unnotched Charpy impact strength of about 2 KJ/m² or more, in some embodiments from about 4 to about 20 KJ/m², and in some embodiments, from about 6 to about 18 KJ/m² and/or a notched Charpy impact strength of about 10 KJ/m² or more, in some embodiments from about 15 to about 50 KJ/m², and in some embodiments, from about 20 to about 40 KJ/m², as determined at a temperature of 23° C. in accordance with ISO 179-1:2010.

Various embodiments of the present invention will now be described in more detail.

### I. Polymer Composition

### A. Polymer Matrix

As indicated above, the polymer matrix contains at least one liquid crystalline polymer. For example, liquid crystalline polymers typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %). Liquid crystalline polymers are generally classified as “thermotropic” to the extent that they can possess a rod-like structure and exhibit a crystalline behavior in their molten state (e.g., thermotropic nematic state). Such polymers typically have a DTUL value of from about 200° C. to about 340° C., in some embodiments from about 210° C. to about 300° C., and in some embodiments, from about 220° C. to about 280° C., as determined in accordance with ISO 75-2:2013 at a load of 1.8 MPa. The polymers also have a relatively high melting temperature, such as from about 250° C. to about 440° C., in some embodiments from about 260° C. to about 400° C., and in some embodiments, from about 300° C. to about 380° C. The polymers may be formed from one or more types of repeating units as is known in the art. A liquid crystalline polymer may, for example, contain one or more aromatic ester repeating units generally represented by the following Formula (I):

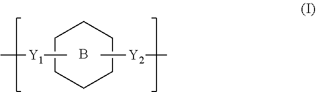

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5-or 6-membered aryl group (e.g., 2,6-naphthalene), or a substituted or unsubstituted 6-membered aryl group linked to a substituted or unsubstituted 5-or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 20 mol. % to about 80 mol. %, in some embodiments from about 25 mol. % to about 75 mol. %, and in some embodiments, from about 30 mol. % to 70 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 50 mol. %, in some embodiments from about 5 mol. % to about 40 mol. %, and in some embodiments, from about 10 mol. % to about 35 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 40 mol. %, in some embodiments from about 2 mol. % to about 35 mol. %, and in some embodiments, from about 5 mol. % to about 30 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although by no means required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, in some embodiments from about 15 mol. % to about 50 mol. %, and in some embodiments, from 16 mol. % to about 30 mol. % of the polymer. In one embodiment, for instance, the repeating units derived from NDA are within the ranges noted above. The liquid crystalline polymer may also contain various other monomers. For example, the polymer may contain repeating units derived from HBA in an amount of from about 20 mol. % to about 60 mol. %, and in some embodiments from about 25 mol. % to about 55 mol. %, and in some embodiments, from about 30 mol. % to about 50 mol. %. The polymer may also contain aromatic dicarboxylic acid(s) (e.g., IA and/or TA) in an amount of from about 1 mol. % to about 15 mol. % and/or aromatic diol(s) (e.g., BP and/or HQ) in an amount of from about 10 mol. % to about 35 mol. %. Of course, in other embodiments, the liquid crystalline polymer may be a “low naphthenic” polymer to the extent that it contains a relatively low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) may be about 10 mol. % or less, in some embodiments about 8 mol. % or less, and in some embodiments, from about 1 mol. % to about 6 mol. % of the polymer.

It is often desired that a substantial portion of the polymer matrix is formed from such high naphthenic polymers. For example, high naphthenic polymers such as described herein typically constitute 50 wt. % or more, in some embodiments about 65 wt. % or more, in some embodiments from about 70 wt. % to 100 wt. %, and in some embodiments, from about 80 wt. % to 100% of the polymer matrix (e.g., 100 wt. %). In some cases, blends of polymers may also be used. For example, low naphthenic liquid crystalline polymers may constitute from about 1 wt. % to about 50 wt. %, in some embodiments from about 2 wt. % to about 40 wt. %, and in some embodiments, from about 5 wt. % to about 30 wt. % of the total amount of liquid crystalline polymers in the composition, and high naphthenic liquid crystalline polymers may constitute from about 50 wt. % to about 99 wt. %, in some embodiments from about 60 wt. % to about 98 wt. %, and in some embodiments, from about 70 wt. % to about 95 wt. % of the total amount of liquid crystalline polymers in the composition.

### B. Thermally Conductive Filler

The polymer composition also contains a thermally conductive filler distributed within the polymer matrix. To help achieve the desired balance between thermal conductivity, heat resistance, high flow, and good mechanical properties, the relative amount of the thermally conductive filler is typically controlled to be within a range of from about 10 to about 250 parts by weight, in some embodiments from about 40 to about 250 parts by weight, in some embodiments from about 60 to about 200 parts by weight, and in some embodiments, from about 80 to about 190 parts by weight per 100 parts by weight of the polymer matrix. The thermally conductive filler may, for instance, constitute from about 20 wt. % to about 70 wt. %, in some embodiments from about 28 wt. % to about 62 wt. %, in some embodiments from about 35 wt. % to about 65 wt. %, and in some embodiments, from about 40 wt. % to about 60 wt. % of the polymer composition.

If desired, the thermally conductive filler may include a material having a high degree of intrinsic thermal conductivity. For example, the polymer composition may be contain a material having an intrinsic thermal conductivity of 50 W/m-K or more, in some embodiments 100 W/m-K or more, and in some embodiments, 150 W/m-K or more. Examples of such high intrinsic thermally conductive materials may include, for instance, boron nitride, aluminum nitride, magnesium silicon nitride, graphite (e.g., expanded graphite), silicon carbide, carbon nanotubes, zinc oxide, magnesium oxide, beryllium oxide, zirconium oxide, yttrium oxide, aluminum powder, and copper powder. While such materials can be employed in certain embodiments, it has been discovered that a high degree of thermal conductivity can be achieved without use of conventional materials having a high degree of intrinsic thermal conductivity. For example, the polymer composition may be generally free of fillers having an intrinsic thermal conductivity. That is, such fillers may constitute about 10 wt. % or less, in some embodiments about 5 wt. % or less, and in some embodiments, from 0 wt. % to about 2 wt. % of the polymer composition (e.g., 0 wt. %).

In one particular embodiment, for instance, the thermally conductive filler may contain mineral particles. When employed, such mineral particles typically constitute from about 70 to about 250 parts by weight, in some embodiments from about 75 to about 200 parts by weight, and in some embodiments, from about 90 to about 190 parts by weight per 100 parts by weight of the polymer matrix. The mineral particles may, for instance, constitute from about 30 wt. % to about 70 wt. %, in some embodiments from about 35 wt. % to about 65 wt. %, and in some embodiments, from about 40 wt. % to about 60 wt. % of the polymer composition. The mineral particles may be formed from a natural and/or synthetic silicate mineral, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. The shape of the particles may vary as desired, such as granular, flake-shaped, etc. The particles typically have a median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

In addition to and/or in lieu of mineral particles, the thermally conductive filler may also contain mineral fibers (also known as “whiskers”). When employed, such mineral fibers typically constitute from about 10 to about 150 parts by weight, in some embodiments from about 15 to about 100 parts by weight, and in some embodiments, from about 20 to about 80 parts by weight per 100 parts by weight of the polymer matrix. The mineral fibers may, for instance, constitute from about 10 wt. % to about 50 wt. %, in some embodiments from about 15 wt. % to about 45 wt. %, and in some embodiments, from about 20 wt. % to about 40 wt. % of the polymer composition. Examples of such mineral fibers include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are inosilicates, such as wollastonite fibers available from Nyco Minerals under the trade designation NYGLOS® (e.g., NYGLOS® 4W or NYGLOS® 8). The mineral fibers may have a median diameter of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. In addition to possessing the size characteristics noted above, the mineral fibers may also have a relatively high aspect ratio (average length divided by median diameter) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

### C. Optional Additives

The polymer composition may also contain a variety of other optional components to help improve its overall properties. For example, the polymer composition may contain a metal hydroxide that is effectively capable of “losing” hydroxide ions during processing with the polymer to initiate chain scission of the polymer, which reduces molecular weight, and in turn, the melt viscosity of the polymer under shear. When employed, the metal hydroxide(s) may constitute from about 0.05 to about 10 parts, in some embodiments from about 0.1 to about 5 parts, and in some embodiments, from about 0.2 to about 3 parts by weight per 100 parts by weight of the polymer matrix. For example, the metal hydroxide(s) may constitute from about 0.01 wt. % to about 5 wt. %, in some embodiments from about 0.05 wt. % to about 4 wt. %, and in some embodiments, from about 0.1 wt. % to about 2 wt. % of the polymer composition.

One example of a suitable metal hydroxide has the general formula M(OH)ₛ, where s is the oxidation state (typically from 1 to 3) and M is a metal, such as a transitional metal, alkali metal, alkaline earth metal, or main group metal. Examples of suitable metal hydroxides may include copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. Also suitable are metal alkoxide compounds that are capable of forming a hydroxyl functional group in the presence of a solvent, such as water. Such compounds may have the general formula M(OR)ₛ, wherein s is the oxidation state (typically from 1 to 3), M is a metal, and R is alkyl. Examples of such metal alkoxides may include copper (II) ethoxide (Cu²⁺(CH₃CH₂O⁻)₂), potassium ethoxide (K⁺(CH₃CH₂O⁻)), sodium ethoxide (Na⁺(CH₃CH₂O⁻)), magnesium ethoxide (Mg²⁺(CH₃CH₂O⁻)₂), calcium ethoxide (Ca²⁺(CH₃CH₂O⁻)₂), etc.; aluminum ethoxide (Al³⁺(CH₃CH₂O⁻)₃), and so forth. In particular embodiments, the metal hydroxide may be in the form of metal hydroxide particles. For instance, the particles may contain at least one aluminum hydroxide having the general formula: Al(OH)ₐO_{b}, where 0≤a≤3 (e.g., 1) and b=(3−a)/2. In one particular embodiment, for example, the particles exhibit a boehmite crystal phase and the aluminum hydroxide has the formula AlO(OH) (“aluminum oxide hydroxide”). The metal hydroxide particles may be needle-shaped, ellipsoidal-shaped, platelet-shaped, spherical-shaped, etc. Regardless, the particles typically have a median particle diameter (D50) of from about 50 to about 800 nanometers, in some embodiments from about 150 to about 700 nanometers, and in some embodiments, from about 250 to about 500 nanometers, as determined by non-invasive back scatter (NIBS) techniques. If desired, the particles may also have a high specific surface area, such as from about 2 square meters per gram (m²/g) to about 100 m²/g, in some embodiments from about 5 m²/g to about 50 m²/g, and in some embodiments, from about 10 m²/g to about 30 m²/g. Surface area may be determined by the physical gas adsorption (BET) method (nitrogen as the adsorption gas) in accordance with ISO 9277:2010. The moisture content may also be relatively low, such as about 5% or less, in some embodiments about 3% or less, and in some embodiments, from about 0.1 to about 1% as determined in accordance with ISO 787-2:1981.

Still other components that can be included in the composition may include, for instance, reinforcing fibers (e.g., glass fibers), pigments (e.g., black pigments), antioxidants, stabilizers, crosslinking agents, lubricants, impact modifiers, flow promoters, and other materials added to enhance properties and processability.

### II. Melt Processing

The manner in which the liquid crystalline polymer, thermally conductive filler, and various other optional additives (e.g., pigment, lubricant, etc.) are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 150° C. to about 450° C., and in some embodiments, from about 250° C. to about 400° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. In-Wheel Motor

Although any suitable shaped part can be formed, the polymer composition of the present invention is particularly useful in electric wheels—e.g., in-wheel motors. For example, an in-wheel motor may be formed that includes a housing that is supported in an inner space of a wheel portion and a stator core that is supported inside the housing. The in-wheel motor may also contain a drive board that is housed inside the housing and controls an electromagnetic force generated in the stator core. The drive board may include, for instance, a heat diffusion plate, as well as one or more boards for performing various functions, such as arithmetic processing, power control, etc. To help improve thermal transfer, the polymer composition described herein may be used to form a variety of aspects of the motor, such as in the housing and/or heat diffusion plate.

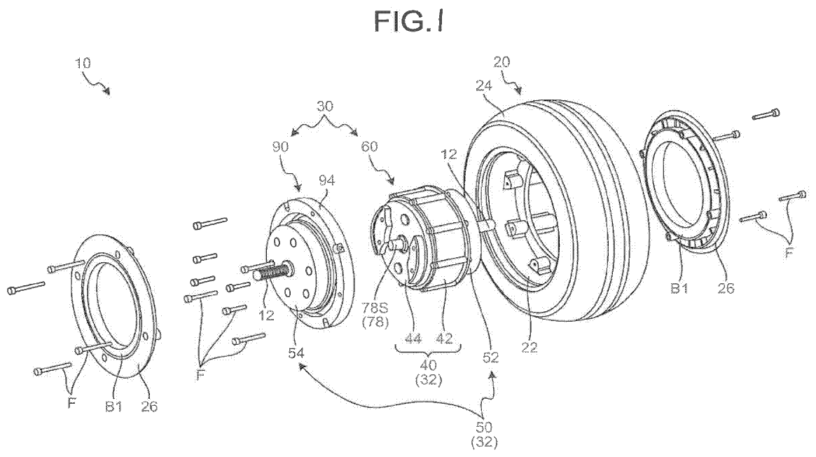

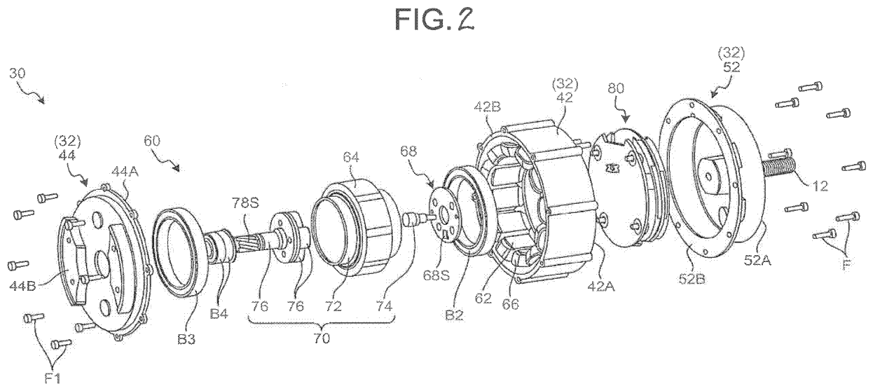

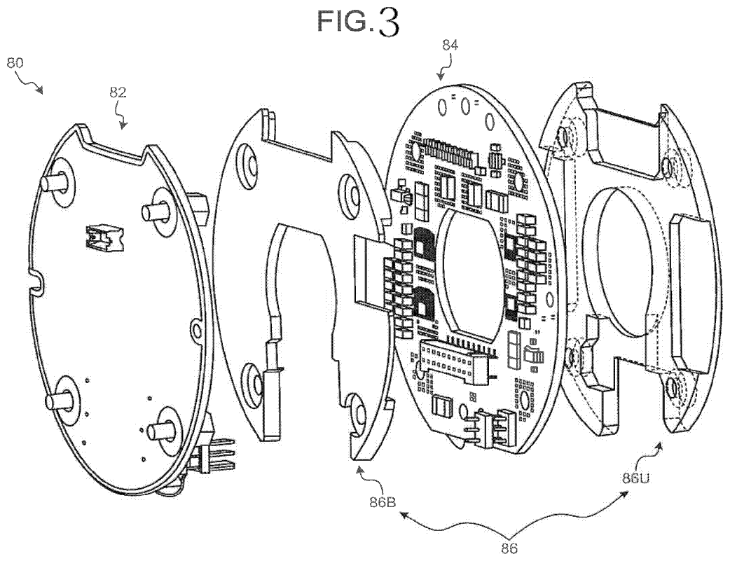

Referring to FIGS. 1-3, for example, one embodiment of an electric wheel 10 is shown that includes a wheel portion 20 and a drive device 30. The drive device 30 is an in-wheel motor provided inside the wheel portion 20. Fixed shafts 12 are fixed on both sides of the drive device 30. The fixed shafts 12 are coaxial with a rotation axis R of the wheel portion 20. The wheel portion 20 rotates with respect to the fixed shafts 12. The wheel portion 20 includes a rim 22, a tire 24, two rim covers 26, and two first bearings B1. The rim 22 typically has a cylindrical shape having the rotation axis as a central axis. The tire 24 is fitted to an outer side of the rim 22. The rim covers 26 are provided so as to cover both ends of the rim 22 in a rotation axis direction, respectively. The rim cover 26 has an annular shape having substantially the same inner diameter as the rim 22. The rim cover 26 is fixed to the rim 22 by fixing members F such as bolts. The rim cover 26 can be formed of, for example, a member such as a synthetic resin. The first bearings B1 are provided inside the rim covers 26, respectively.

The drive device 30 includes a housing 32, a motor portion 60, a drive board 80, and a speed reducer 90. The first bearings B1 rotatably support the rim covers 26 and the rim 22 of the wheel portion 20 with respect to the housing 32 of the drive device 30. The housing 32 is provided inside the rim 22, the rim cover 26, and the first bearing B1. The housing 32 includes an inner housing 40 provided at a central portion in the rotation axis direction and two outer housings 50 provided adjacent, respectively, to both sides of the inner housing 40 in the rotation axis direction. The inner housing 40 includes a first inner housing 42 and a second inner housing 44. One of the two outer housings 50 is a first outer housing 52, and the other of the two outer housing 50 is a second outer housing 54. The first inner housing 42 is provided at a central portion in the rotation axis direction inside the rim 22. An outer peripheral surface of the first inner housing 42 is provided so as to be spaced apart from an inner peripheral surface of the rim 22. The first inner housing 42 has a cylindrical shape having the rotation axis as a central axis. The first inner housing 42 has an end surface 42A closing one end portion thereof in the rotation axis direction. The first inner housing 42 also has an end surface 42B at an edge portion of an end portion thereof on a side opposite to the end surface 42A. The second inner housing 44 is provided at a central portion in the rotation axis direction inside the rim 22. An outer peripheral surface of the second inner housing 44 is provided so as to be spaced apart from the inner peripheral surface of the rim 22. The second inner housing 44 has a cylindrical shape having the rotation axis as a central axis. The second inner housing 44 has a function as a lid closing an end portion of the first inner housing 42 on the end surface 42B side. The second inner housing 44 has a flange-shaped end surface 44A at an end portion thereof on the first inner housing 42 side. The end surface 44A is provided to be in surface-contact with the end surface 42B of the first inner housing 42. The second inner housing 44 has protruding portions 44B protruding to a side opposite to the end surface 44A. The second inner housing 44 and the first inner housing 42 house the motor portion 60.

The first outer housing 52 is provided adjacent to the inner housing 40 in the rotation axis direction inside the first bearing B1. The first outer housing 52 is provided adjacent to the first inner housing 42 in the illustrated embodiment. The first outer housing 52 has a cylindrical shape having the rotation axis as a central axis. The first outer housing 52 has a heat dissipation surface 52A at an end portion thereof on a side opposite to the first inner housing 42. In the embodiment, an outer diameter of the heat dissipation surface 52A is equal to an inner diameter of the first bearing B1. The first outer housing 52 has a flange-shaped end surface 52B at an end portion thereof on the first inner housing 42 side. The end surface 52B is provided to be in surface-contact with a part of the end surface 42A of the first inner housing 42. The first outer housing 52 is fixed to the first inner housing 42 by the fixing members F, such as the bolts on the end surface 52B. The second outer housing 54 is provided adjacent to the inner housing 40 in the rotation axis direction inside the first bearing B1. The second outer housing 54 is provided adjacent to the second inner housing 44 in the illustrated embodiment. The second outer housing 54 has a cylindrical shape or a columnar shape having the rotation axis as a central axis. The second outer housing 54 is provided to be in surface-contact with a part of the second inner housing 44. The second outer housing 54 has a function as a fixed support member of a speed reducer 90.

The motor portion 60 is housed in the first inner housing 42 and the second inner housing 44. The motor portion 60 includes a stator core 62, a rotor 64, a motor coil 66, an encoder board 68, and a first planetary gear mechanism 70. The first planetary gear mechanism 70 includes a rotor internal gear 72, a sun gear 74, four planetary gears 76, a rotation support member 78, a second bearing B2, a third bearing B3, and a fourth bearing B4. The stator core 62 has a cylindrical shape having the rotation axis as a central axis. The stator core 62 is provided to be fitted to an inner side of the first inner housing 42. An outer peripheral surface of the stator core 62 and an inner peripheral surface of the first inner housing 42 are provided to be in surface-contact with each other. The rotor 64 has a cylindrical shape having the rotation axis as a central axis. The rotor 64 is provided inside the stator core 62. The motor coil 66 is wound between a plurality of grooves formed in the stator core 62. An electromagnetic force is generated between the stator core 62 and the rotor 64 by a current flowing through the motor coil 66, such that the rotor 64 rotates around the rotation axis. The rotor internal gear 72 has a cylindrical shape having the rotation axis as a central axis. The rotor internal gear 72 is provided to be fitted to an inner side of the rotor 64. The rotor internal gear 72 is rotatably supported with respect to the first inner housing 42 via the second bearing B2. The rotor internal gear 72 rotates integrally with the rotor 64. The rotor internal gear 72 is rotatably supported with respect to the second inner housing 44 via the third bearing B3. The sun gear 74 has the rotation axis as a central axis. The sun gear 74 is provided inside the rotor internal gear 72. The sun gear 74 is fixedly provided on the end surface 42A side of the first inner housing 42. The four planetary gears 76 are evenly provided on an outer circumference of the sun gear 74. The planetary gears 76 revolve around the sun gear 74 in the same direction while rotating in the same direction as the rotor internal gear 72 along with rotation of the rotor internal gear 72.

A rotation support member is rotatably supported with respect to the second inner housing 44 via the fourth bearing B4 and is provided integrally with an output shaft 78S of the motor portion 60. The rotation support member rotates along with the revolution of the planetary gear 76. The output shaft 78S is provided so as to protrude from an end surface of the second inner housing 44 on the second outer housing 54 side. The output shaft 78S has a function as a sun gear of a speed reducer 90. The encoder board 68 has a disk shape orthogonal to the rotation axis. The encoder board 68 is fixedly provided in the first inner housing 42 inside the rotor internal gear 72 and is provided with a sensor integrated circuit 68S on a surface thereof that detects the number of rotations and a rotation speed of the rotor internal gear 72. The rotor internal gear 72 rotates integrally with the rotor 64. Therefore, the sensor integrated circuit 68S can detect the number of rotations and a rotation speed of the rotor 64 by detecting the number of rotations and the rotation speed of the rotor internal gear 72.

The drive board 80 is provided inside the first outer housing 52. The drive board 80 is provided to be spaced apart from the motor portion 60 housed in the first inner housing 42 and the second inner housing 44. The drive board 80 includes a first board 82, a second board 84, and two heat diffusion plates 86. The drive board 80 has a two-story structure in which the first board 82 and the second board 84 are arranged in parallel, in the embodiment. The drive board 80 may be provided by one sheet, but it is possible to contribute to miniaturization of the drive device 30 and the electric wheel 10 by making the drive board 80 the two-story structure. In addition, the drive board 80 may be provided outside the housing 32. For example, the drive board 80 may be provided inside another housing attached to a frame of the two-wheeled vehicle on which the electric wheel 10 is mounted. In embodiments in which the drive board 80 is not provided in the housing 32, the first inner housing 42 and the first outer housing 52 may be provided integrally with each other. The first board 82 has a disk shape orthogonal to the rotation axis. The first board 82 includes an arithmetic processing unit that controls the drive of the motor portion 60 on the basis of a predetermined arithmetic program. The arithmetic processing unit controls the drive of the motor portion 60 on the basis of the number of rotations and the rotation speed of the rotor internal gear 72 detected by the sensor integrated circuit 68S of the encoder board 68. The arithmetic processing unit is, for example, a central processing unit (CPU). The second board 84 has a disk shape orthogonal to the rotation axis R. The second board 84 includes a power control unit that controls power energizing the motor coil 66. The power control unit of the second board 84 includes a power semiconductor.

The heat diffusion plates 86 are an integrated heat spreader. The integrated heat spreader has a structure that diffuses heat to enhance a heat dissipation effect. The heat diffusion plates 86 include a first heat diffusion plate 86B and a second heat diffusion plate 86U. The first heat diffusion plate 86B is provided between the first board 82 and the second board 84. At least a part of the second heat diffusion plate 86U is in surface-contact with and fixed to an inner side of the first outer housing 52. The speed reducer 90 includes a second planetary gear mechanism. The second planetary gear mechanism includes the output shaft 78S of the rotation support member 78, an internal gear 94, two planetary gears (not shown), the second outer housing 54, and a fifth bearing (not shown). The internal gear 94 has substantially the same inner diameter as the rim 22. The internal gear 94 is provided between the second inner housing 44 and the second outer housing 54 in the rotation axis direction. The internal gear 94 is fixed to the rim 22 by the fixing members F, such as bolts.

Generally speaking, any portion of the wheel portion 20 and/or drive device 30 shown in FIGS. 1-3 may contain the polymer composition described herein. For example, the polymer composition may be used to form the housing 32 (e.g., first inner housing 42, second inner housing 44, first outer housing 52, second outer housing 54, etc.), motor portion 60, drive board 80 (e.g., first board 82, second board 84, heat diffusion plates 86, etc.), and so forth. In one particular embodiment, for instance, the polymer composition may be used to form one or both of the heat diffusion plates 86.

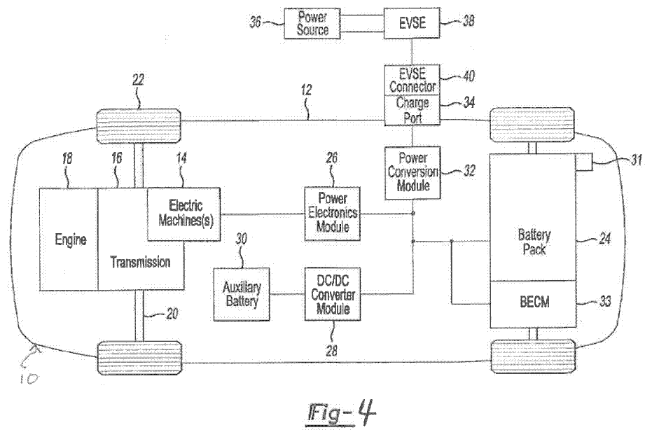

The in-wheel motor may be employed in a wide variety of product applications, but is particularly beneficial for use in an electric motor of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 4, for instance, one embodiment of an electric vehicle 12 that includes a powertrain 10 is shown. The powertrain 10 contains one or more electric machines 14 connected to a transmission 16, which in turn is mechanically connected to a drive shaft 12 and drive wheels 22, which may an in-wheel motor as described herein. Although by no means required, the transmission 16 in this particular embodiment is also connected to an engine 18, though the description herein is equally applicable to a pure electric vehicle. The electric machines 14 may be an electric motor containing a stator/rotor system to provide propulsion and deceleration capability. The powertrain 110 also includes a propulsion source, such as a battery module 24, which stores and provides energy for use by the electric machines 14. The battery module 24 typically provides a high voltage current output (e.g., DC current at a voltage of from about 400 volts to about 800 volts) from one or more battery cell arrays that may include one or more battery cells.

The powertrain 10 may also contain at least one power electronics module 26 that is connected to the battery module 24 (also commonly referred to as a battery pack) and that may contain a power converter (e.g., converter, etc., as well as combinations thereof). The power electronics module 26 is typically electrically connected to the electric machines 14 and provides the ability to bi-directionally transfer electrical energy between the battery module 24 and the electric machines 14. For example, the battery module 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery module 24. The battery module 24 may also provide energy for other vehicle electrical systems. For example, the powertrain may employ a DC/DC converter module 28 that converts the high voltage DC output from the battery module 24 to a low voltage DC supply that is compatible with other vehicle loads, such as compressors and electric heaters. In a typical vehicle, the low-voltage systems are electrically connected to an auxiliary battery (e.g., 12V battery). A battery energy control module (BECM) 33 may also be present that is in communication with the battery module 24 that acts as a controller for the battery module 24 and may include an electronic monitoring system that manages temperature and charge state of each of the battery cells. The battery module 24 may also have a temperature sensor 31. The temperature sensor 31 may be in communication with the BECM 33 to provide temperature data regarding the battery module 24. The temperature sensor 31 may also be located on or near the battery cells within the traction battery 24. It is also contemplated that more than one temperature sensor 31 may be used to monitor temperature of the battery cells.

The battery module 24 may be recharged by an external power source 36, such as an electrical outlet. The external power source 36 may be electrically connected to electric vehicle supply equipment (EVSE) that regulates and manages the transfer of electrical energy between the power source 36 and the vehicle 12. The EVSE 38 may have a charge connector 40 for plugging into a charge port 34 of the vehicle 12. The charge port 34 may be any type of port configured to transfer power from the EVSE 38 to the vehicle 12 and may be electrically connected to a charger or on-board power conversion module 32. The power conversion module 32 may condition the power supplied from the EVSE 38 to provide the proper voltage and current levels to the battery module 24. The power conversion module 32 may interface with the EVSE 38 to coordinate the delivery of power to the vehicle 12.

### Test Methods

Thermal Conductivity: As is known in the art, the thermal diffusivity of a sample in various directions (in-plane, cross-plane, through-plane) may be initially determined based on the laser flash method in accordance with ASTM E1461-13 (2022). The thermal conductivity (in-plane, cross-plane, and through-plane) may then be calculated according to the following formula: Thermal Conductivity (W/m*K)=Cp*ρ*α, where Cp is the specific heat capacity (J/kgK) of the sample, ρ is the intrinsic density (kg/m³) of the sample as determined in accordance with ISO 11831-1:2019 (Method A), and α is the measured thermal diffusivity (m²/s).

Melt Viscosity: The melt viscosity (Pa-s) may be determined in accordance with ISO 11443:2021 at a shear rate of 1,000 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm. The melt viscosity is typically determined at a temperature 15° C. above the melting temperature of the polymer and/or composition, such as about 350° C.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-3:2018. Under the DSC procedure, samples were heated and cooled at 20° C. per minute as stated in ISO Standard 10350 using DSC measurements conducted on a TA Q2000 Instrument.

Tensile Modulus, Tensile Stress at Break, and Tensile strain at Break: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

### EXAMPLES 1-2

The following two (2) commercially available samples were compounded and injection molded for use in an in-wheel motor.

| | Ex. 1 | Ex. 1 | Ex. 2 | Ex. 2 |
|---|---|---|---|---|
| | (wt. %) | (parts) | (wt. %) | (parts) |
| LCP 1 | — | 100 | 65.45 | 100 |
| LCP 2 | 46.3 | | — | |
| Nylgos ® 8 | — | — | 30.0 | 46 |
| Boron Nitride | 53.7 | 116 | — | — |
| Lubricant | — | — | 0.3 | 0.5 |
| Carbon Black | — | — | 3.75 | 6 |

LCP 1 is formed from 73% HBA and 27% HNA. LCP 2 is believed to be formed from 50% HBA, 25% BP, and 25% TA. The samples were tested for mechanical properties, thermal properties, and thermal conductivity as described herein. The results are set forth below.

| | Ex. 1 | Ex. 2 |
|---|---|---|
| Tensile Modulus (MPa) | 9,887 | 14,000 |
| Tensile Strength (MPa) | 50 | 143 |
| Tensile Elongation (%) | 0.86 | 2.7 |
| Flexural Modulus (MPa) | 13,500 | 13,000 |
| Flexural Strength (MPa) | 79 | 160 |
| Charpy Impact Strength | 7.0 | 29 |
| (Un-Notched) (kJ/m²) | | |
| Charpy Impact Strength | 3.6 | 10 |
| (Notched) (kJ/m²) | | |
| DTUL (° C.) | 228 | 240 |
| Tm (° C.) | 345-350 | 335 |
| Melt Viscosity (Pa-s) at 1,000 s⁻¹ | 254 (380° C.) | 42 |
| TC, In-Plane (W/mK) | 9.4 | 2.5 |
| TC, Cross Plane (W/mK) | 9.0 | 1.0 |
| TC, Through Plane (W/mK) | 1.9 | 0.6 |
| Dielectric Strength (kV/mm) | — | 30 |
| CTI (V) | — | 175 |

### EXAMPLE 3

The following sample was compounded and injection molded for use in an in-wheel motor.

| | Ex. 3 (wt. %) | Ex. 3 (parts) |
|---|---|---|
| LCP 3 | 37.3 | 100 |
| LCP 1 | 5.6 | |
| Talc | 54.0 | 126 |
| Hydrated Alumina | 0.4 | 0.9 |
| Lubricant | 0.3 | 0.7 |
| Carbon Black | 2.4 | 6 |

LCP 3 is formed from 43% HBA, 20% NDA, 9% TA, and 28% HQ. The samples were tested for mechanical properties, thermal properties, and thermal conductivity as described herein. The results are set forth below.

| | Ex. 3 |
|---|---|
| Tensile Modulus (MPa) | 10,000 |
| Tensile Strength (MPa) | 82 |
| Tensile Elongation (%) | 2.1 |
| Flexural Modulus (MPa) | 10,000 |
| Flexural Strength (MPa) | 109 |
| Charpy Impact Strength (Un-Notched) (kJ/m²) | 13 |
| Charpy Impact Strength (Notched) (kJ/m²) | — |
| DTUL (° C.) | 261 |
| Melt Viscosity (MPa-s) at 1,000 s⁻¹ | 43.6 |
| Tm (° C.) | 315 |
| TC, In-Plane (W/mK) | 4.8 |
| TC, Cross Plane (W/mK) | 3.4 |
| TC, Through Plane (W/mK) | 0.8 |
| Dielectric Strength (kV/mm) | 41 |
| CTI (V) | 250 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. An in-wheel motor comprising a housing that is supported in an inner space of a wheel portion and a stator core that is supported inside the housing, wherein the motor includes a polymer composition that comprises a polymer matrix that includes a thermotropic liquid crystalline polymer and a thermally conductive filler distributed within the polymer matrix, further wherein the polymer composition exhibits an in-plane thermal conductivity of about 2 W/m-K or more as determined in accordance with ASTM E1461-13 (2022).

2. The in-wheel motor of claim 1, wherein the polymer composition
exhibits a melt viscosity of about 300 Pa-s or less as determined in accordance with ISO 11443:2021 at a shear rate of 1,000 s-¹ and temperature of about 15° C. above the melting temperature of the composition.

3. The in-wheel motor of claim 1, wherein the polymer composition exhibits a deflection temperature under load of about 170° C. or more as determined in accordance with ISO 75:2013 at a load of 1.8 MPa.

4. The in-wheel motor of claim 1, wherein the polymer composition exhibits a melting temperature of about 250° C. to about 440° C.

5. The in-wheel motor of claim 1, wherein the thermotropic liquid crystalline polymer contains repeating units derived from one or more aromatic dicarboxylic acids, one or more aromatic hydroxycarboxylic acids, or a combination thereof.

6. The in-wheel motor of claim 5, wherein the aromatic hydroxycarboxylic acids include 4-hydroxybenzoic acid, 6-hydroxy-2-naphthoic acid, or a combination thereof.

7. The in-wheel motor of claim 6, wherein the aromatic dicarboxylic acids include terephthalic acid, isophthalic acid, 2,6-naphthalenedicarboxylic acid, or a combination thereof.

8. The in-wheel motor of claim 5, wherein the liquid crystalline polymer further contains repeating units derived from one or more aromatic diols.

9. The in-wheel motor of claim 8, wherein the aromatic diols include hydroquinone, 4,4′-biphenol, or a combination thereof.

10. The in-wheel motor of claim 1, wherein the thermotropic liquid crystalline polymer is wholly aromatic.

11. The in-wheel motor of claim 1, wherein the thermotropic liquid crystalline polymer includes repeating units derived from naphthenic hydroxycarboxylic and/or dicarboxylic acids in an amount of about 10 mol. % or more.

12. The in-wheel motor of claim 1, wherein the polymer composition exhibits a cross-plane thermal conductivity of about 0.8 W/m-K or more as determined in accordance with ASTM E 1461-13 (2022).

13. The in-wheel motor of claim 1, wherein the polymer composition exhibits an in-plane thermal conductivity of from about 4 to about 8 W/m-K, as determined in accordance with ASTM E 1461-13 (2022).

14. The in-wheel motor of claim 1, wherein the polymer composition exhibits a dielectric strength of about 10 kilovolts per millimeter or more as determined in accordance with IEC 60234-1:2013.

15. The in-wheel motor of claim 1, wherein the thermally conductive filler includes mineral particles.

16. The in-wheel motor of claim 15, wherein the mineral particles include talc.

17. The in-wheel motor of claim 15, wherein the mineral particles constitute from about 70 to about 250 parts by weight per 100 parts by weight of the polymer matrix.

18. The in-wheel motor of claim 15, wherein the mineral particles have a median diameter of from about 1 to about 25 micrometers, specific surface area of from about 1 to about 50 m²/g as determined in accordance with DIN 66131:1993, and/or moisture content of about 5% or less as determined in accordance with ISO 787-2:1981 at a temperature of 105° C.

19. The in-wheel motor of claim 1, wherein the thermally conductive filler includes mineral fibers.

20. The in-wheel motor of claim 19, wherein the mineral fibers include wollastonite.

21. The in-wheel motor of claim 19, wherein the mineral fibers constitute from about 10 to about 150 parts by weight per 100 parts by weight of the polymer matrix.

22. The in-wheel motor of claim 1, wherein the polymer composition is free of fillers having an intrinsic thermal conductivity of 100 W/m-K or more.

23. The in-wheel motor of claim 1, wherein the polymer composition exhibits a comparative tracking index of about 170 volts or more as determined in accordance with IEC 60112:2003 at a thickness of 3 millimeters.

24. The in-wheel motor of claim 1, wherein the housing includes the polymer composition.

25. The in-wheel motor of claim 1, further comprising a drive board that is housed inside the housing and controls an electromagnetic force generated in the stator core.

26. The in-wheel motor of claim 25, wherein the drive board includes the polymer composition.

27. The in-wheel motor of claim 26, wherein the drive board includes a heat diffusion plate that contains the polymer composition.

28. An electric wheel comprising the in-wheel motor of claim 1.

29. An electric vehicle comprising an electric wheel of claim 28.
